(19) United States
(12) Patent Application Publication
(10) Pub. No.: US 2023/0067780 A1
(43) Pub. Date: Mar. 2, 2023

(54) FLOW INFORMATION COLLECTION APPARATUS AND METHOD OF GENERATING FLOW INFORMATION

(71) Applicant: ALAXALA Networks Corporation, Kawasaki-shi (JP)

(72) Inventors: Makoto SHIMODA, Kawasaki (JP); Hiroto SAKURAI, Kawasaki (JP); Keisuke SATO, Kawasaki (JP)

(21) Appl. No.: 17/879,821

(22) Filed: Aug. 3, 2022

(30) Foreign Application Priority Data
Aug. 27, 2021 (JP) 2021-139197

(51) Int. Cl. H04L 43/0894; H04L 43/02; H04L 43/18

(52) U.S. Cl. CPC H04L 43/0894; H04L 43/02; H04L 43/18

(57) ABSTRACT

A flow information collection apparatus connects to an analyzer for monitoring flows to be able to communicate, generates flow information by aggregating packets having common communication attributes in units of a first time period, generates short-term analysis information indicating short-term characteristics of a flow by repeatedly analyzing the packets used to generate the flow information in a second time period shorter than the first time period with respect to the short-term characteristics of the flow, includes the generated short-term analysis information into the flow information, generates a packet including the flow information including the short-term analysis information, and sends the packet to the analyzer.

### CLAIM OF PRIORITY

The present application claims priority from Japanese patent application JP 2021-139197 filed on Aug. 27, 2021, the content of which is hereby incorporated by reference into this application.

### BACKGROUND OF THE INVENTION

This invention relates to an apparatus for collecting flow information on the flows in a network and a method of generating flow information.

There is a network monitoring system such that a flow information collection apparatus having a monitoring function of NetFlow (refer to RFC 3954 “Cisco Systems NetFlow Services Export Version 9”) collects port mirroring packets transferred from a relay apparatus, generates flow information, and transmits the flow information to a network flow analyzer (hereinafter, referred to as analyzer), and the analyzer analyzes the network flows.

According to the above-described configuration, the traffic in a network is converted into statistical information and then transmit in the form of NetFlow packets; accordingly, the load of the analyzer can be made low.

JP 2008-187666 A provides a method of concurrently calculating the bandwidths of the overall (long-term) traffic and a local (short-term) traffic with low load to the analyzer by switching repeatedly capturing packets in a minute time period and stopping it, without using NetFlow technology.

### SUMMARY OF THE INVENTION

The network flow monitoring system using the NetFlow technology has a disadvantage that it cannot detect a short-term change in a flow like a microburst, because traffic amount included in the flow information is averaged over an aggregation period.

To solve this issue, the aggregation period can be shortened to raise the resolution of the analysis by the analyzer. However, the increase in NetFlow packets increases the load to the analyzer. Furthermore, an excessively shortened aggregation period lowers the efficiency of flow collection and impairs the advantages of NetFlow.

The method according to JP 2008-187666 A has the following problems: (1) a short-term change in traffic amount could be overlooked because packet capturing is stopped for a certain period; and (2) the load to the analyzer increases with increase of traffic amount because the analyzer directly captures packets.

This invention aims to transmit flow information with which the analyzer can detect flow changes on a long-term basis and a short-term basis.

A representative example of the present invention disclosed in this specification is as follows: a flow information collection apparatus comprises an arithmetic device, a storage device coupled to the arithmetic device; and a network interface coupled to the arithmetic device. The flow information collection apparatus is configured to couple to an analyzer to be able to communicate with the analyzer. The arithmetic device is configured to: generate flow information by aggregating a plurality of packets having common communication attributes in units of a first time period; generate short-term analysis information indicating short-term characteristics of a flow by repeatedly analyzing the plurality of packets used to generate the flow information with respect to short-term characteristics of the flow in a second time period shorter than the first time period, and add the generated short-term analysis information to the flow information; generate a packet including the flow information adding the short-term analysis information; and transmit the packet to the analyzer.

An aspect of this invention enables transmitting the flow information including information indicating long-term characteristics and short-term characteristics of a flow to the analyzer. Thus, the analyzer can detect flow changes on a long-term basis and a short-term basis.

### BRIEF DESCRIPTION OF THE DRAWINGS

The present invention can be appreciated by the description which follows in conjunction with the following figures, wherein:

FIG. 1 is a diagram illustrating an example of a configuration of a network flow monitoring system in Embodiment 1;

FIGS. 2A and 2B are block diagrams illustrating an example of a configuration of a flow information collection apparatus in Embodiment 1;

FIG. 3 is a diagram illustrating an example of the data structure of short-term analysis configuration information in Embodiment 1;

FIG. 4 is a diagram illustrating an example of the data structure of interface statistical information in Embodiment 1;

FIGS. 5A, 5B, 5C, and 5D are diagrams illustrating an example of the data structure of flow information DB in Embodiment 1;

FIG. 6 is a flowchart for illustrating the outline of the processing of flow information recording control module in Embodiment 1;

FIGS. 7A and 7B are a flowchart illustrating details of a short-term analysis to be performed by the flow information recording control module in Embodiment 1;

FIG. 8 is a flowchart for illustrating the details of a receive rate peak analysis to be performed by the flow information recording control module in Embodiment 1;

FIG. 9 is a flowchart for illustrating the details of a receive rate variance analysis to be performed by the flow information recording control module in Embodiment 1;

FIG. 10 is a flowchart for illustrating the details of a burst analysis to be performed by the flow information recording control module in Embodiment 1;

FIG. 11 is a flowchart for illustrating the details of a receive rate modification to be performed by the flow information recording control module in Embodiment 1;

FIG. 12 is a diagram illustrating an example of the data format of flow information included in a NetFlow packet to be generated by a NetFlow packet generation module in Embodiment 1;

FIG. 13 is a flowchart illustrating an example of transmitting the NetFlow packet to be performed by the flow information collection apparatus in Embodiment 1;

FIGS. 14A and 14B are block diagrams illustrating an example of a configuration of an analyzer in Embodiment 1;

FIGS. 15A and 15B are diagrams illustrating an example of the data structure of a flow information DB in Embodiment 1;

FIG. 16 is a diagram illustrating an example of information presented by a NetFlow visualization module in Embodiment 1;

FIG. 17 is a diagram illustrating a network flow monitoring system in Embodiment 2; and

FIG. 18 is a diagram illustrating a network flow monitoring system in Embodiment 3.

### DETAILED DESCRIPTION OF EMBODIMENTS

Now, a description is given of an embodiment of this invention referring to the drawings. It should be noted that this invention is not to be construed by limiting the invention to the content described in the following embodiment. In a configuration of this invention described below, the same or similar components or functions are assigned with the same reference numerals, and a redundant description thereof is omitted here. The position, size, shape, range, and others of each component illustrated in, for example, the drawings may not represent the actual position, size, shape, range, and other metrics in order to facilitate understanding of this invention. Thus, this invention is not limited to the position, size, shape, range, and others described in, for example, the drawings.

### Embodiment 1

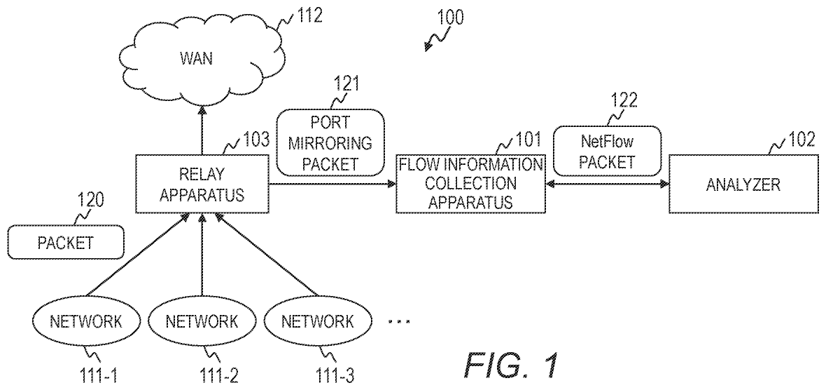

FIG. 1 is a diagram illustrating an example of a configuration of a network flow monitoring system 100 in Embodiment 1.

The network flow monitoring system 100 includes a relay apparatus 103, a flow information collection apparatus 101, and an analyzer 102.

The relay apparatus 103 connects to a plurality of networks 111-1, 111-2, 111-3, a WAN 112, and the flow information collection apparatus 101. When the networks 111-1, 111-2, and 111-3 do not need to be distinguished, the following description refers to each of them as network 111. The relay apparatus 103 relays packets 120 communicated between networks 111 and between a network 111 and the WAN 112. The relay apparatus 103 further transmits port mirroring packets 121 obtained by copying the packets to be relayed to the flow information collection apparatus 101.

The flow information collection apparatus 101 connects to the relay apparatus 103 and the analyzer 102. The flow information collection apparatus 101 generates flow information and short-term analysis information based on the port mirroring packets 121. The flow information collection apparatus 101 transmits NetFlow packets 122 including flow information to the analyzer 102. The flow information collection apparatus 101 may have the functions of the relay apparatus 103.

The analyzer 102 analyzes a network flow using the flow information included in the NetFlow packets 122.

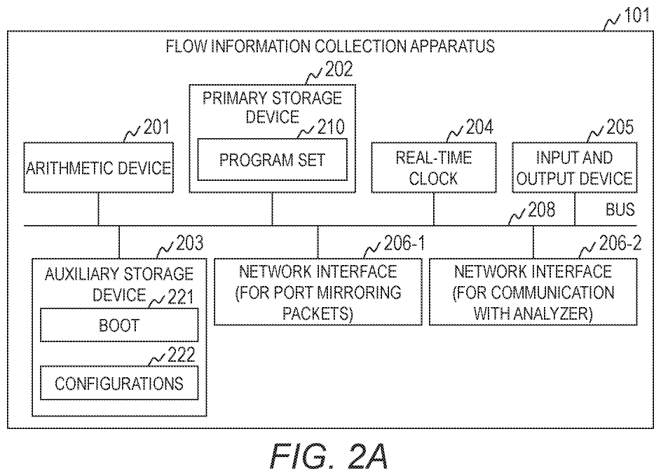

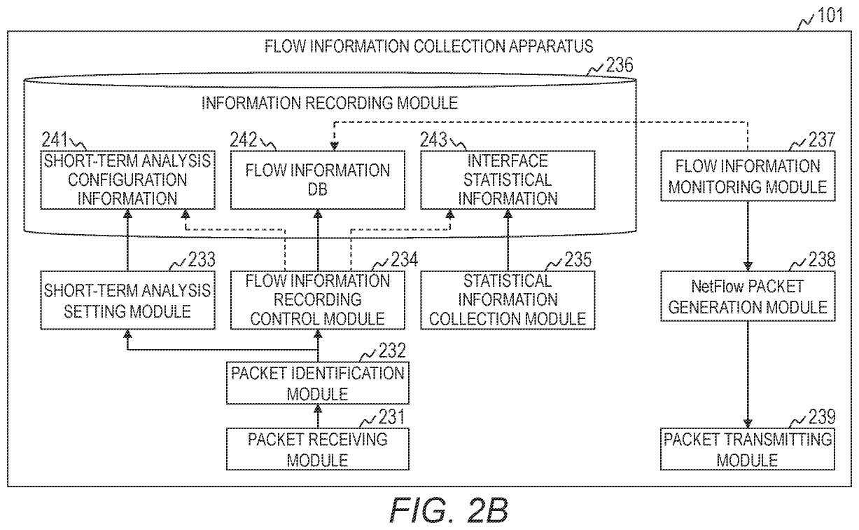

FIGS. 2A and 2B are block diagrams illustrating an example of a configuration of the flow information collection apparatus 101 in Embodiment 1.

The hardware configuration is described first. The flow information collection apparatus 101 includes an arithmetic device 201, a primary storage device 202, an auxiliary storage device 203, a real-time clock 204, an input and output device 205, a network interface 206-1, and a network interface 206-2. These hardware components are interconnected by a bus 208.

The arithmetic device 201 is a central processing unit (CPU), for example, and executes programs stored in a storage device such as the primary storage device 202. The arithmetic device 201 performs processing in accordance with a program to work as a function unit (module) for implementing a specific function. In the following description, when some processing is described with the function unit as the subject of the sentence, this indicates that the arithmetic device 201 executes a program for implementing the function unit.

As to the function units of the flow information collection apparatus 101, a plurality of function units may be grouped into one function unit, or one function unit may be divided into a plurality of function units.

The primary storage device 202 is a random-access memory (RAM), for example, and stores programs executed by the arithmetic device 201 and information used by the programs. The primary storage device 202 may also be used as a work area. The primary storage device 202 in Embodiment 1 stores a program set 210 for implementing various functions. The details of the program set 210 will be described later.

The auxiliary storage device 203 is a storage device such as a read-only memory (ROM), a flash memory, or a hard disk drive (HDD), for example, and stores data persistently. The auxiliary storage device in Embodiment 1 stores a BOOT 221 and configurations 222. The details of the BOOT 221 and the configurations 222 will be described later.

The real-time clock 204 holds time information.

The input and output device 205 may be a keyboard, a mouse, a touch panel, a display monitor, and the like. If the flow information collection apparatus 101 is operable through a network, it does not need to include the input and output device 205.

The network interface 206-1 is a network interface for communicating with the relay apparatus 103. The flow information collection apparatus 101 receives port mirroring packets 121 through the network interface 206-1. The network interface 206-2 is an interface for communicating with the analyzer 102. When the network interfaces 206-1 and 206-2 do not need to be distinguished, the following description refers to each of them as network interface 206.

Next, the software configuration is described. In FIG. 2B, the solid lines represent inputting and outputting information; and the dotted lines represent referring to information.

The BOOT 221 is a program to be executed when the flow information collection apparatus 101 starts. The arithmetic device 201 retrieves the BOOT 221 from the auxiliary storage device 203, loads it to the primary storage device 202, and executes it. The arithmetic device 201 executing the BOOT 221 loads the program set 210 stored in the auxiliary storage device 203 to the primary storage device 202 and executes the programs therein. The flow information collection apparatus 101 may obtain the program set 210 from an external device connected through the network interface 206, using the File Transfer Protocol (FTP), for example.

The configurations 222 include configuration information for controlling the programs included in the program set 210. For example, initial values for short-term analysis configuration information 241 are stored in the configurations 222. In this case, the arithmetic device 201 sets these initial values to the short-term analysis configuration information 241 in starting the program set 210. The configurations 222 may be preinstalled or set by the analyzer 102.

The program set 210 includes a packet receiving module 231, a packet identification module 232, a short-term analysis setting module 233, a flow information recording control module 234, a statistical information collection module 235, an information recording module 236, a flow information monitoring module 237, a NetFlow packet generation module 238, and a packet transmitting module 239.

The information recording module 236 manages a data store for storing a variety of information. Specifically, the information recording module 236 manages the short-term analysis configuration information 241, a flow information DB 242, and interface statistical information 243. The short-term analysis configuration information 241, the flow information DB 242, and the interface statistical information 243 may be stored in the primary storage device 202 or the auxiliary storage device 203.

The packet receiving module 231 performs receiving processing of packets arrived at the network interfaces 206.

The packet identification module 232 identifies and allocates the received packets. Specifically, in the case of receiving a packet (a port mirroring packet 121) received through the network interface 206-1, the packet identification module 232 outputs the packet to the flow information recording control module 234. In the case of receiving a packet (a control packet) through the network interface 206-2, the packet identification module 232 outputs the received packet to the short-term analysis setting module 233.

The short-term analysis setting module 233 sets or updates, via the information recording module 236, the short-term analysis configuration information 241 based on the control packet received from the packet identification module 232.

The flow information recording control module 234 extracts values to be included in flow information from the port mirroring packet 121 received from the packet identification module 232 and records, via the information recording module 236, the extracted values to corresponding flow information in the flow information DB 242. The flow information recording control module 234 executes short-term analysis on the flow information with reference to the short-term analysis configuration information 241 and records, via the information recording module 236, the analysis result to the flow information DB 242.

The statistical information collection module 235 periodically obtains statistical information held by the network interfaces 206 and records, via the information recording module 236, it to the interface statistical information 243.

The flow information monitoring module 237 obtains flow information on which the monitoring period has expired from the flow information DB 242 and outputs it to the NetFlow packet generation module 238.

The NetFlow packet generation module 238 generates a NetFlow packet 122 including the flow information received from the flow information monitoring module 237 and outputs the generated NetFlow packet 122 to the packet transmitting module 239.

The packet transmitting module 239 transmits the NetFlow packet 122 to the analyzer 102 through the network interface 206-2.

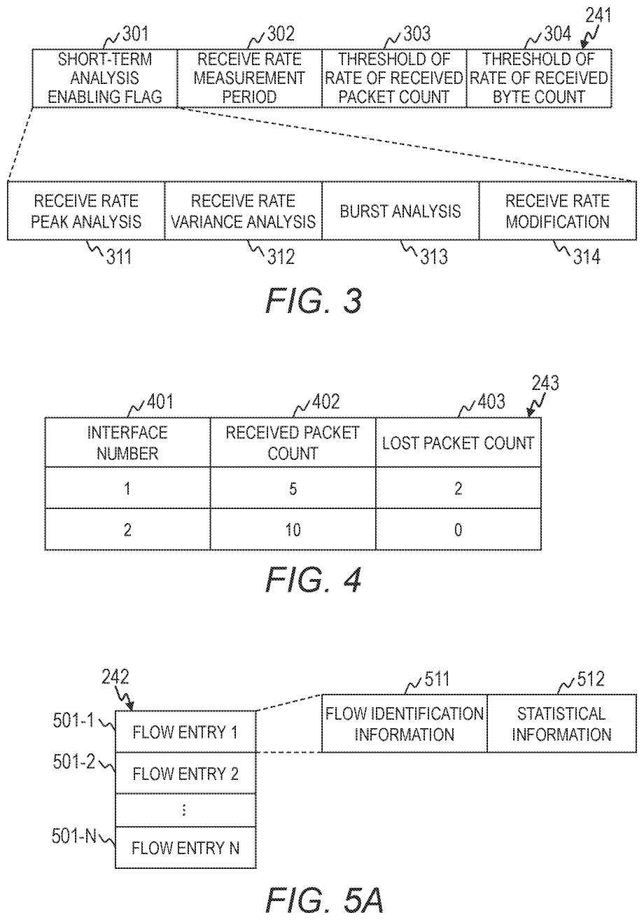

FIG. 3 is a diagram illustrating an example of the data structure of the short-term analysis configuration information 241 in Embodiment 1.

The short-term analysis configuration information 241 includes a short-term analysis enabling flag 301, a receive rate measurement period 302, a threshold of rate of received packet count 303, and a threshold of rate of received byte count 304.

The short-term analysis enabling flag 301 is a bit string for setting flags for controlling whether to enable or disable processing related to short-term analysis. The short-term analysis enabling flag 301 includes four bits 311, 312, 313, and 314. Each bit is to be assigned a value “1” meaning “enabled” or a value “0” meaning “disabled”.

The receive rate measurement period 302 is a field for storing a time window to be a time unit of short-term analysis (a time period to keep measuring the receive rate).

The threshold of rate of received packet count 303 and the threshold of rate of received byte count 304 are fields for storing thresholds to be used in the short-term analysis.

Now, the outline of the processing to be managed with the short-term analysis enabling flag 301 is described.

The processing associated with the bit 311 is to obtain a peak value of a rate of a received packet count during a receive rate measurement period and an occurrence time of the peak, and a peak value of the rate of a received byte count during the receive rate measurement period and an occurrence time of the peak. The following description refers to the processing associated with the bit 311 as receive rate peak analysis.

The processing associated with the bit 312 is to calculate a variance of the rate of the received packet count and a variance of the rate of the received byte count during the receive rate measurement period. The following description refers to the processing associated with the bit 312 as receive rate variance analysis.

The processing associated with the bit 313 is to count how many times amount of increase in the rate of the received packet count exceeds a threshold (the threshold of rate of received packet count) during the receive rate measurement period, and how many times amount of increase in the rate of the received byte count exceeds a threshold (the threshold of rate of received bytes count) during the receive rate measurement period. The following description refers to the processing associated with the bit 313 as burst analysis.

The processing associated with the bit 314 is to modify the rate of the received packet count and the rate of the received byte count based on a packet loss rate in the receive rate measurement period. The following description refers to the processing associated with the bit 314 as receive rate modification.

FIG. 4 is a diagram illustrating an example of the data structure of the interface statistical information 243 in Embodiment 1.

The interface statistical information 243 is information in a table format and stores entries each including an interface number 401, a received packet count 402, and a lost packet count 403. One entry corresponds to one network interface 206. The fields included in an entry are not limited to the foregoing ones. One or more of the fields can be excluded and one or more other fields can be included.

The interface number 401 is a field for storing a number for uniquely identifying a network interface 206. This number is assigned in advance to manage the kind of the interface.

The received packet count 402 and the lost packet count 403 are fields for storing statistical values counted and managed by the network interface 206. These statistical values are merely examples and the statistical values are not limited to these. For example, an entry may include fields for storing a number of received bytes and a number of transmitted packets.

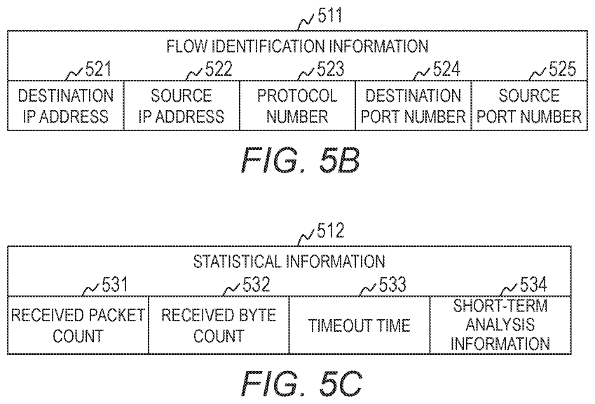

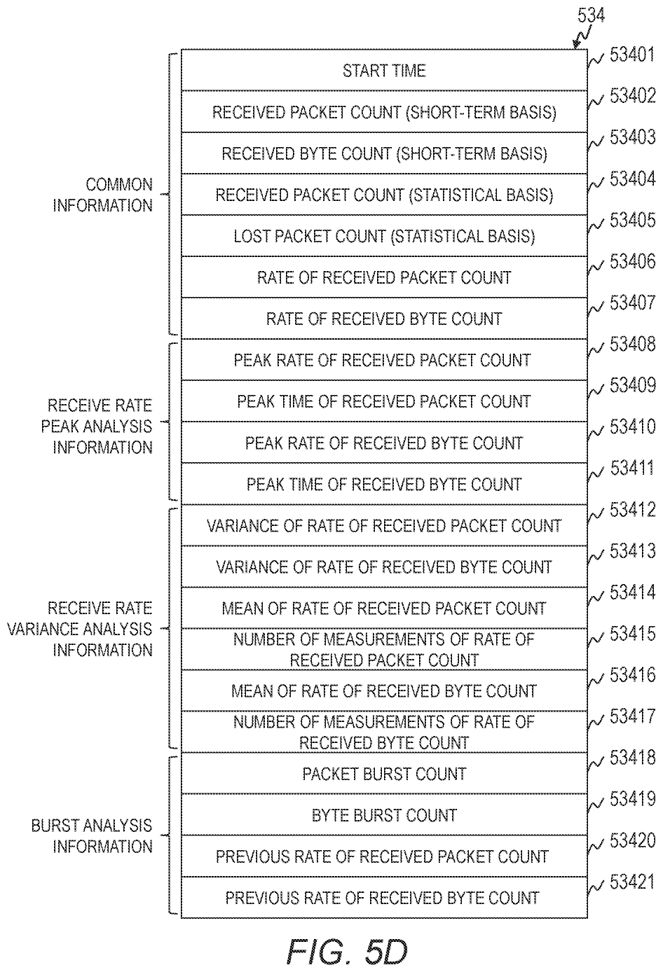

FIGS. 5A, 5B, 5C, and 5D are diagrams illustrating an example of the data structure of the flow information DB 242 in Embodiment 1.

As illustrated in FIG. 5A, the flow information DB 242 stores flow entries 501. The flow information DB 242 in FIG. 5A stores N flow entries 501. One entry corresponds to a piece of flow information.

One flow entry 501 includes flow identification information 511 and statistical information 512.

The flow identification information 511 are fields for storing information for identifying a flow. As shown in FIG. 5B, the flow identification information 511 includes a destination IP address 521, a source IP address 522, a protocol number 523, a destination port number 524, and a source port number 525. These fields included in the flow identification information 511 are merely examples and the actual fields are not limited to these. For example, information such as a VLAN ID and a MAC address can be included.

The statistical information 512 are fields for storing information on a flow. As shown in FIG. 5C, the statistical information 512 includes a received packet count 531, a received byte count 532, a timeout time 533, and short-term analysis information 534.

The received packet count 531 and the received byte count 532 store a number of the packets and a number of the bytes received since the flow entry 501 is registered to the flow information DB 252 until the time set to the timeout time 533.

The timeout time 533 stores a time obtained from the real-time clock 204 and a time after elapse of a flow monitoring period (n seconds), for example. The flow monitoring period may be defined in the configurations 222.

The short-term analysis information 534 are fields for storing temporary information required to execute short-term analysis and its results. As shown in FIG. 5D, the short-term analysis information 534 includes fields of common information, fields of information on the receive rate peak analysis, fields of information on the receive rate variance analysis, and fields of information on the burst analysis.

The common information includes a start time 53401, a received packet count (short-term basis) 53402, a received byte count (short-term basis) 53403, a received packet count (statistical basis) 53404, a lost packet count (statistical basis) 53405, a rate of received packet count 53406, and a rate of received byte count 53407. The rate of received packet count 53406 is a field for storing a receive rate of the number of packets. The rate of received byte count 53407 is a field for storing a receive rate in amount of data.

The receive rate peak analysis information are fields to be used in the receive rate peak analysis that is executed when a value “1” is set to the bit 311. Specifically, it includes a peak rate of received packet count 53408, a peak time of received packet count 53409, a peak rate of received byte count 53410, and a peak time of received byte count 53411. The peak rate of received packet count 53408 is a field for storing a peak value of the receive rate in the number of packets. The peak rate of received byte count 53410 is a field for storing a peak value of the receive rate in amount of data.

The receive rate variance analysis information are fields to be used in the receive rate variance analysis that is executed when a value “1” is set to the bit 312. Specifically, it includes a variance of rate of received packet count 53412, a variance of rate of received byte count 53413, a mean of rate of received packet count 53414, a number of measurements of rate of received packet count 53415, a mean of rate of received byte count 53416, and a number of measurements of rate of received byte count 53417. The variance of rate of received packet count 53412 is a field for storing a variance of the receive rate in the number of packets. The variance of rate of received byte count 53413 is a field for storing a variance of the receive rate in amount of data.

The burst analysis information are fields to be used in the burst analysis that is executed when a value “1” is set to the bit 313. Specifically, it includes a packet burst count 53418, a byte burst count 53419, a previous rate of received packet count 53420, and a previous rate of received byte count 53421. The packet burst count 53418 is a field for storing the number of microbursts caused by locally increase in packets. The byte burst count 53419 is a field for storing the number of microbursts caused by locally increase in data amount.

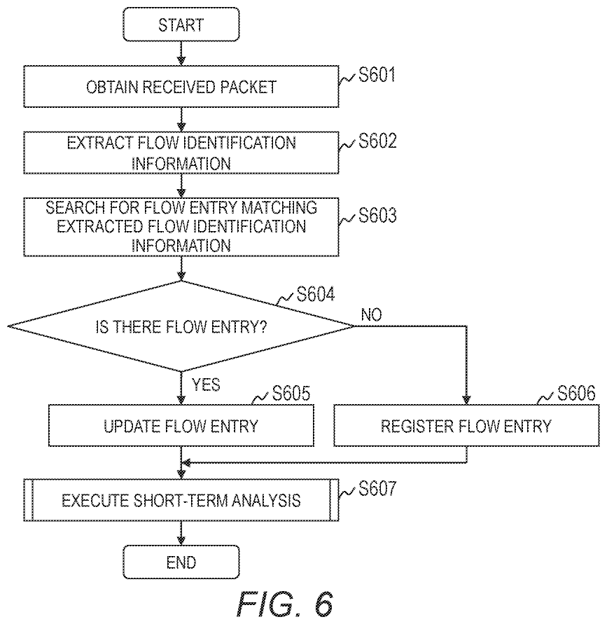

FIG. 6 is a flowchart for illustrating the outline of the processing of the flow information recording control module 234 in Embodiment 1.

In a case of obtaining a received packet (a port mirroring packet 121) from the packet identification module 232 (Step S601), the flow information recording control module 234 extracts flow identification information from the received packet (Step S602).

The flow information recording control module 234 refers the flow information DB 242 to retrieve a flow entry 501 matching the extracted flow identification information (Step S603), and determines whether such the flow entry 501 exists (Step S604).

In a case where the flow entry 501 matching the extracted flow identification information exists (YES at Step S604), the flow information recording control module 234 updates the flow entry 501 (Step S605) and proceeds to Step S607.

Specifically, the flow information recording control module 234 adds 1 to the received packet count 531 of the flow entry 501 and adds the bytes of the received packet to the received byte count 532.

In a case where the flow entry 501 matching the extracted flow identification information does not exist (NO at Step S604), the flow information recording control module 234 register a new flow entry 501 to the flow information DB 242 (Step S606) and proceeds to Step S607.

Specifically, the flow information recording control module 234 adds a new flow entry 501 to the flow information DB 242 and sets the extracted flow identification information in the flow identification information 511 of the added flow entry 501. The flow information recording control module 234 sets 1 to the received packet count 531 of the added flow entry 501 and sets the bytes of the received packet to the received byte count 532. The flow information recording control module 234 calculates the timeout time based on the current time and sets the calculated time to the timeout time 533 of the added flow entry 501.

At Step S607, the flow information recording control module 234 executes short-term analysis (Step S607) and thereafter, terminates the processing.

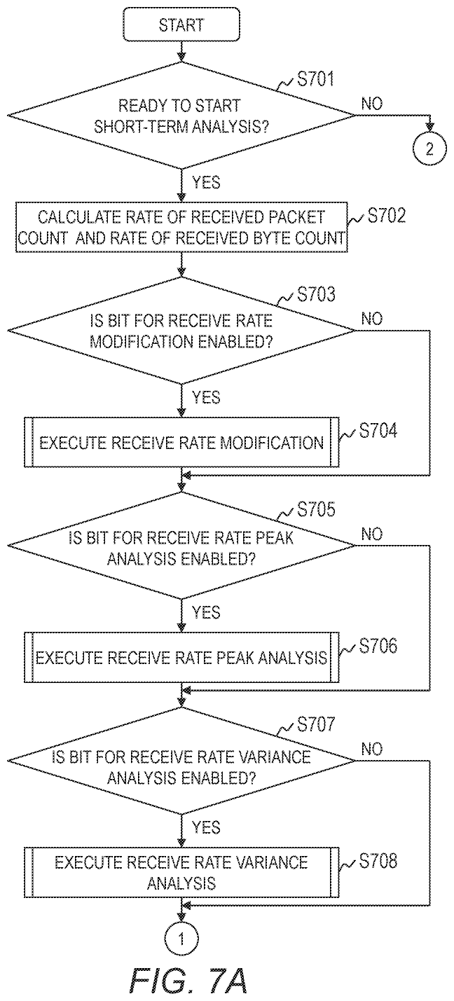

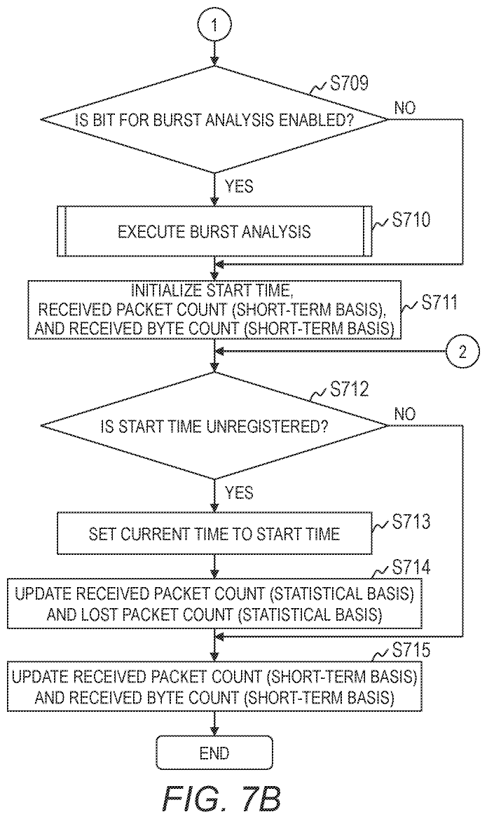

FIGS. 7A and 7B are a flowchart illustrating details of the short-term analysis to be performed by the flow information recording control module 234 in Embodiment 1.

The flow information recording control module 234 determines whether short-term analysis is ready to be started (Step S701).

Specifically, the flow information recording control module 234 determines whether the start time 53401 of the flow entry 501 includes a time and whether the time of receipt of the received packet is later than a time obtained by adding the period included in the receive rate measurement period 302 to the start time. In a case where these two conditions are satisfied, the flow information recording control module 234 determines that short-term analysis is ready to be started. In this embodiment, the flow information collection apparatus 101 repeatedly executes the short-term analysis within the flow monitoring period with a cycle shorter than the flow monitoring period.

In a case where short-term analysis is not ready to be started (NO at Step S701), the flow information recording control module 234 proceeds to Step S712.

In a case where short-term analysis is ready to be started (YES at Step S701), the flow information recording control module 234 calculates a rate of a received packet count and a rate of a receive byte count (Step S702).

Specifically, the flow information recording control module 234 calculates the rate of the received packet count and the rate of the received byte count in the receive rate measurement period, using the received packet count (short-term basis) 53402 and the received byte count (short-term basis) 53403 in the flow entry 501. The flow information recording control module 234 sets the calculated values to the rate of received packet count 53406 and the rate of received byte count 53407. This embodiment uses one second as a unit time to calculate these rates. The receive rate measurement period can be used as a unit time.

The flow information recording control module 234 determines whether the bit 314 for the receive rate modification is enabled (Step S703).

Specifically, the flow information recording control module 234 determines whether the value of the bit 314 is “1” with reference to the short-term analysis configuration information 241. In a case where the value of the bit 314 is “1”, the flow information recording control module 234 determines that the flag for the receive rate modification is enabled.

In a case where the bit 314 for the receive rate modification is not enabled (NO at Step S703), the flow information recording control module 234 proceeds to Step S705.

In a case where the bit 314 for the receive rate modification is enabled (YES at Step S703), the flow information recording control module 234 executes the receive rate modification (Step S704) and thereafter, proceeds to Step S705.

At Step S705, the flow information recording control module 234 determines whether the bit 311 for the receive rate peak analysis is enabled (Step S705).

Specifically, the flow information recording control module 234 determines whether the value of the bit 311 is “1” with reference to the short-term analysis configuration information 241. In a case where the value of the bit 311 is “1”, the flow information recording control module 234 determines that the bit 311 for the receive rate peak analysis is enabled.

In a case where the bit 311 for the receive rate peak analysis is not enabled (NO at Step S705), the flow information recording control module 234 proceeds to Step S707.

In a case where the bit 311 for the receive rate peak analysis is enabled (YES at Step S705), the flow information recording control module 234 executes the receive rate peak analysis (Step S706) and thereafter, proceeds to Step S707.

At Step S707, the flow information recording control module 234 determines whether the bit 312 for the receive rate variance analysis is enabled (Step S707).

Specifically, the flow information recording control module 234 determines whether the value of the bit 312 is “1” with reference to the short-term analysis configuration information 241. In a case where the value of the bit 312 is “1”, the flow information recording control module 234 determines that the bit 312 for the receive rate variance analysis is enabled.

In a case where the bit 312 for the receive rate peak analysis is not enabled (NO at Step S707), the flow information recording control module 234 proceeds to Step S709.

In a case where the bit 312 for the receive rate peak analysis is enabled (YES at Step S707), the flow information recording control module 234 executes the receive rate variance analysis (Step S708) and thereafter, proceeds to Step S709.

At Step S709, the flow information recording control module 234 determines whether the bit 313 for the burst analysis is enabled (Step S709).

Specifically, the flow information recording control module 234 determines whether the value of the bit 313 is “1” with reference to the short-term analysis configuration information 241. In a case where the value of the bit 313 is “1”, the flow information recording control module 234 determines that the bit 313 for the burst analysis is enabled.

In a case where the bit 313 for the burst analysis is not enabled (NO at Step S709), the flow information recording control module 234 proceeds to Step S711.

In a case where the bit 313 for the burst analysis is enabled (YES at Step S709), the flow information recording control module 234 executes the burst analysis (Step S710) and thereafter, proceeds to Step S711.

At Step S711, the flow information recording control module 234 initializes the start time 53401, the received packet count (short-term basis) 53402, and the received byte count (short-term basis) 53403 in the common information (Step S711) and thereafter, proceeds to Step S712.

At Step S712, the flow information recording control module 234 determines whether the start time is unregistered (Step S712).

Specifically, the flow information recording control module 234 determines whether the start time 53401 in the common information includes a value.

In a case where a start time is registered (NO at Step S712), the flow information recording control module 234 proceeds to Step S715.

In a case where a start time is unregistered (YES at Step S712), the flow information recording control module 234 sets the current time in the start time 53401 in the common information (Step S713). The flow information recording control module 234 further obtains the lost packet count 402 and the lost packet count 403 from the entry corresponding to the network interface 206-1 in the interface statistical information 243 and sets the obtained values to the received packet count (statistical basis) 53404 and the lost packet count (statistical basis) 53405 in the common information (Step S714). Thereafter, the flow information recording control module 234 proceeds to Step S715.

At Step S715, the flow information recording control module 234 updates the received packet count (short-term basis) 53402 and the received byte count (short-term basis) 53403 (Step S715). Thereafter, the flow information recording control module 234 terminates the short-term analysis.

Specifically, the flow information recording control module 234 adds 1 to the received packet count (short-term basis) 53402 and adds the bytes of the received packet to the received byte count (short-term basis) 53403.

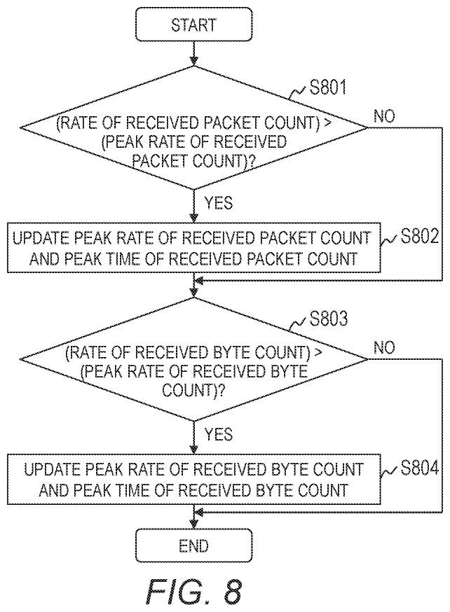

FIG. 8 is a flowchart for illustrating the details of the receive rate peak analysis to be performed by the flow information recording control module 234 in Embodiment 1.

The flow information recording control module 234 determines whether the value of the rate of received packet count 53406 is larger than the value of the peak rate of received packet count 53408 (Step S801).

In a case where the value of the rate of received packet count 53406 is not larger than the value of the peak rate of received packet count 53408 (NO at Step S801), the flow information recording control module 234 proceeds to Step S803.

In a case where the value of the rate of received packet count 53406 is larger than the value of the peak rate of received packet count 53408 (YES at Step S801), the flow information recording control module 234 updates the peak rate of received packet count 53408 (Step S802) and thereafter, proceeds to Step S803.

Specifically, the flow information recording control module 234 sets the value of the rate of received packet count 53406 to the peak rate of received packet count 53408 and sets the current time obtained from the real-time clock 204 to the peak time of received packet count 53409.

At Step S803, the flow information recording control module 234 determines whether the value of the rate of received byte count 53407 is larger than the value of the peak rate of received byte count 53410 (Step S803).

In a case where the value of the rate of received byte count 53407 is not larger than the value of the peak rate of received byte count 53410 (NO at Step S803), the flow information recording control module 234 terminates the receive rate peak analysis.

In a case where the value of the rate of received byte count 53407 is larger than the value of the peak rate of received byte count 53410 (YES at Step S803), the flow information recording control module 234 updates the peak rate of received byte count 53410 (Step S804) and thereafter, terminates the receive rate peak analysis.

Specifically, the flow information recording control module 234 sets the value of the rate of received byte count 53407 to the peak rate of received byte count 53410 and sets the current time obtained from the real-time clock 204 to the peak time of received byte count 53411.

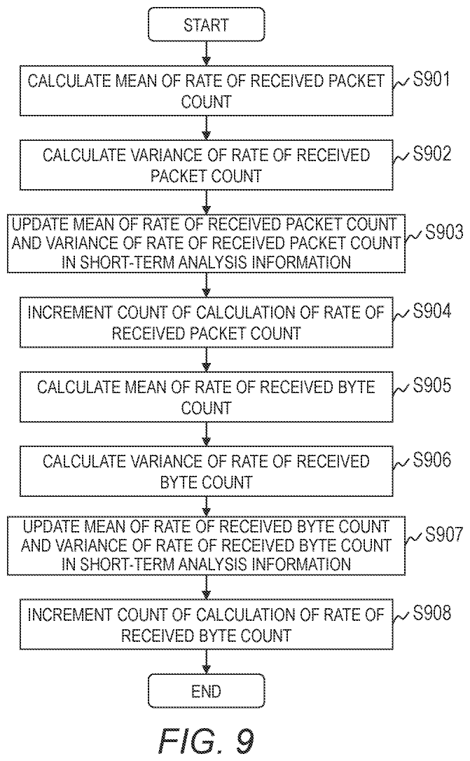

FIG. 9 is a flowchart for illustrating the details of the receive rate variance analysis to be performed by the flow information recording control module 234 in Embodiment 1.

The flow information recording control module 234 calculates the mean of the rate of the received packet count (Step S901). For example, the flow information recording control module 234 uses the following sequential update formula (1) to calculate the mean of rate of the received packet count.

$$\begin{matrix}[ Formula 1 ] & \\ {μ}_{n + 1} = \frac{1}{n + 1} ( n {μ}_{n} + {x}_{n + 1} ) & ( 1 )\end{matrix}$$

Where n represents the value of the number of measurements of rate of received packet count 53415, xₙ₊₁ represents the value of the rate of received packet count 53406, μₙ represents the value of the mean of rate of received packet count 53414, and μₙ₊₁ represents the mean of the rate of the received packet count to be calculated at Step S901.

The flow information recording control module 234 calculates the variance of the rate of the received packet count (Step S902). For example, the flow information recording control module 234 uses the following sequential update formula (2) to calculate the variance of the rate of the received packet count.

$$\begin{matrix}[ Formula 2 ] & \\ {σ}_{n + 1}^{2} = \frac{n ( {σ}_{n}^{2} + {μ}_{n}^{2} ) + {x}_{n + 1}^{2}}{n + 1} - {μ}_{n + 1}^{2} & ( 2 )\end{matrix}$$

Where n represents the value of the number of measurements of rate of received packet count 53415, xₙ₊₁ represents the value of the rate of received packet count 53406, μₙ represents the value of the mean of rate of received packet count 53414, μₙ₊₁ represents the mean of the rate of the received packet count calculated at Step S901, σₙ² represents the value of the variance of rate of received packet count 53412, and σₙ₊₁² is the variance of the rate of the received packet count to be calculated at Step S902.

The flow information recording control module 234 updates the mean of rate of received packet count 53414 and the variance of rate of received packet count 53412 in the short-term analysis information 534 (Step S903).

Specifically, the flow information recording control module 234 sets the value calculated at Step S901 to the mean of rate of received packet count 53414 and the value calculated at Step S902 to the variance of rate of received packet count 53412.

The flow information recording control module 234 increments a count of calculation of the rate of the received packet count (Step S904).

Specifically, the flow information recording control module 234 adds 1 to the value of the number of measurements of rate of received packet count 53415.

The flow information recording control module 234 calculates the mean of the rate of the received byte count (Step S905). For example, the flow information recording control module 234 uses the same sequential update formula as the formula (1) to calculate the mean of the rate of the received byte count, although n represents the value of the number of measurements of rate of received byte count 53417, xₙ₊₁ represents the value of the rate of received byte count 53407, μₙ represents the value of the mean of rate of received byte count 53416, μₙ₊₁ represents the mean of the rate of the received byte count to be calculated at Step S905.

The flow information recording control module 234 calculates the variance of the rate of the received byte count (Step S906). For example, the flow information recording control module 234 uses the same sequential update formula as the formula (2), although n represents the value of the number of measurements of rate of received byte count 53417, xₙ₊₁ represents the value of the rate of received byte count 53407, μₙ represents the value of the mean of rate of received byte count 53416, μₙ₊₁ represents the mean of the rate of the received byte count calculated at Step S905, σₙ² represents the value of the variance of rate of received byte count 53413, and σₙ₊₁² represents the variance of the rate of the received byte count to be calculated at Step S906.

The flow information recording control module 234 updates the mean of rate of received byte count 53416 and the variance of rate of received byte count 53413 in the short-term analysis information 534 (Step S907).

Specifically, the flow information recording control module 234 sets the value calculated at Step S905 to the mean of rate of received byte count 53416 and the value calculated at Step S906 to the variance of rate of received byte count 53413.

The flow information recording control module 234 increments a count of calculation of the rate of the received byte count (Step S908) and terminates the receive rate variance analysis.

Specifically, the flow information recording control module 234 adds 1 to the value of the number of measurements of rate of received byte count 53417.

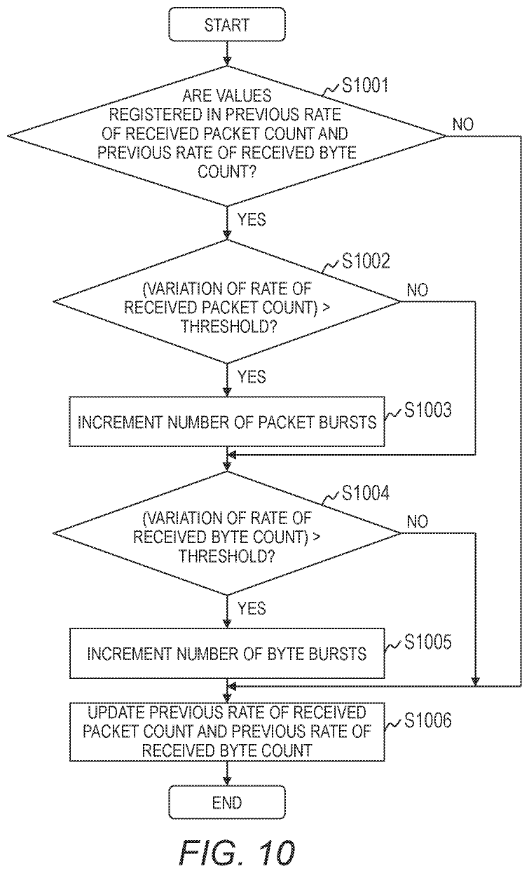

FIG. 10 is a flowchart for illustrating the details of the burst analysis to be performed by the flow information recording control module 234 in Embodiment 1.

The flow information recording control module 234 determines whether values are registered in the previous rate of received packet count 53420 and the previous rate of received byte count 53421 (Step S1001).

In a case where values are not registered in the previous rate of received packet count 53420 and the previous rate of received byte count 53421 (No at Step S1001), the flow information recording control module 234 updates the previous rate of received packet count 53420 and the previous rate of received byte count 53421 (Step S1006) and terminates the burst analysis.

Specifically, the flow information recording control module 234 sets values of the rate of received packet count 53406 and the rate of received byte count 53407 to the previous rate of received packet count 53420 and the previous rate of received byte count 53421.

In a case where values are registered in the previous rate of received packet count 53420 and the previous rate of received byte count 53421 (Yes at Step S1001), the flow information recording control module 234 determines whether the variation of the rate of the received packet count is larger than the threshold (Step S1002).

Specifically, the flow information recording control module 234 calculates a value by subtracting the value of the previous rate of received packet count 53420 from the value of the rate of received packet count 53406 and determines whether the calculated value is larger than the value of the threshold of rate of received packet count 303.

In a case where the variation of the rate of the received packet count is not larger than the threshold (No at Step S1002), the flow information recording control module 234 proceeds to Step S1004.

In a case where the variation of rate of received packet count is larger than the threshold (Yes at Step S1002), the flow information recording control module 234 determines that a burst occurs because of the increase in packets, and increments the number of burst occurrences of the received packet count (Step S1003). Then, the flow information recording control module 234 proceeds to Step S1004.

Specifically, the flow information recording control module 234 adds 1 to the value of the packet burst count 53418.

At Step S1004, the flow information recording control module 234 determines whether the variation of the rate of the received byte count is larger than the threshold (Step S1004).

Specifically, the flow information recording control module 234 calculates a value by subtracting the value of the previous rate of received byte count 53421 from the value of the rate of received byte count 53407 and determines whether the calculated value is larger than the value of the threshold of rate of received byte count 304.

In a case where the variation of the rate of the received byte count is not larger than the threshold (No at Step S1004), the flow information recording control module 234 proceeds to Step S1006.

In a case where the variation of the rate of the received byte count is larger than the threshold (Yes at Step S1004), the flow information recording control module 234 determines that a burst occurs because of the increase in received bytes, and increments the number of burst occurrences of the received byte count (Step S1005). Then, the flow information recording control module 234 proceeds to Step S1006.

Specifically, the flow information recording control module 234 adds 1 to the value of the byte burst count 53419.

At Step S1006, the flow information recording control module 234 updates the previous rate of received packet count 53420 and the previous rate of received byte count 53421 (Step S1006) and terminates the burst analysis.

Specifically, the flow information recording control module 234 sets the values of the rate of received packet count 53406 and the rate of received byte count 53407 to the previous rate of received packet count 53420 and the previous rate of received byte count 53421.

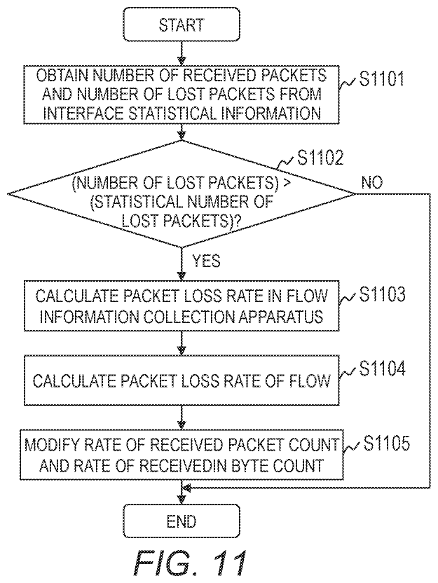

FIG. 11 is a flowchart for illustrating the details of the receive rate modification to be performed by the flow information recording control module 234 in Embodiment 1.

It is assumed that the flow information collection apparatus 101 in Embodiment 1 employ random early detection (RED) to control its own load by discarding packets stochastically at the network interface 206 when the number of port mirroring packets 121 exceeds its collection capability.

The flow information recording control module 234 obtains the number of received packets and the number of lost packets at the network interface 206 that receives port mirroring packets 121 from the interface statistical information 243 (Step S1101).

Specifically, the flow information recording control module 234 accesses the interface statistical information 243 and retrieves the entry storing the identification number of the network interface 206 that receives port mirroring packets in the interface number 401. The flow information recording control module 234 obtains the values of the received packet count 402 and the lost packet count 403 in the detected entry.

The flow information recording control module 234 determines whether the number of lost packets is larger than the statistical number of lost packets (Step S1102).

Specifically, the flow information recording control module 234 determines whether the value of the number of lost packets 403 is larger than the lost packet count (statistical basis) 53405.

In a case where the number of lost packets is not larger than the statistical number of lost packets (No at Step S1102), the flow information recording control module 234 terminates the receive rate modification.

In a case where the number of lost packets is larger than the statistical number of lost packets (Yes at Step S1102), the flow information recording control module 234 calculates the overall packet loss rate in the flow information collection apparatus 101 (Step S1103), for example with the following formula (3).

$$\begin{matrix}[ Formula 3 ] & \\ L = \frac{{P}_{D}}{P + {P}_{D}} & ( 3 )\end{matrix}$$

Where P represents the value obtained by subtracting the value of the received packet count (statistical basis) 53404 from the value of the received packet count 402, P_{D} represents the value obtained by subtracting the value of the lost packet count (statistical basis) 53405 from the value of the lost packet count 403, and L represents the overall packet loss rate of the flow information collection apparatus 101.

The flow information recording control module 234 calculates the packet loss rate of the flow the received packet belongs to (Step S1104).

Since the network interface 206-1 discards packets by RED, it can be regarded that packets of all flows are lost at the same rate as the overall packet loss rate of the flow information collection apparatus 101. For this reason, the packet loss rate of a flow can be given by the following formula (4).

[Formula 4]

L_{flow}=L (4)

Where L_{flow} represents the packet loss rate of the flow the received packet belongs to.

The flow information recording control module 234 modifies the rate of the received packet count and the rate of the received byte count (Step S1105), and terminates the receive rate modification.

For example, the flow information recording control module 234 calculates the modified rate of the received packet count using the following formula (5) and calculates the modified rate of the received byte count using the following formula (6).

$$\begin{matrix}[ Formula 5 ] & \\ {R}_{pkt \_ flow}^{′} = \frac{{R}_{pkt \_ flow}}{1 - {L}_{flow}} & ( 5 )\end{matrix}$$

Where R_{pkt_flow} represents the rate of the received packet count (the value of the rate of received packet count 53406) before modification, R′_{pkt_flow} represents the rate of the received packet count after modification, and L_{flow} represents the packet loss rate of the flow.

$$\begin{matrix}[ Formula 6 ] & \\ {R}_{Byte \_ flow} = \frac{{B}_{flow}}{{P}_{flow}} \times {R}_{pkt \_ flow}^{′} & ( 6 )\end{matrix}$$

Where P_{flow} represents the value of the received packet count (short-term basis) 53402, B_{flow} represents the value of the received byte count (short-term basis) 53403, R′_{pkt_flow} represents the modified rate of the received packet count, and R′_{Byte_flow} represents the modified rate of the received byte count.

The flow information recording control module 234 stores the calculated rate of the received packet count and the calculated rate of the received byte count to the rate of received packet count 53406 and the rate of received byte count 53407.

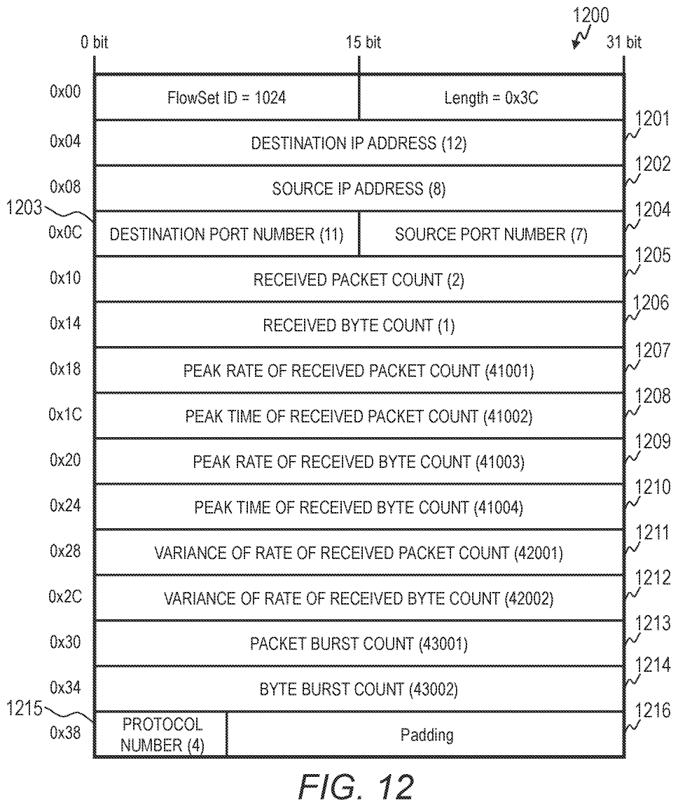

FIG. 12 is a diagram illustrating an example of the data format of flow information included in the NetFlow packet 122 to be generated by the NetFlow packet generation module 238 in Embodiment 1.

A NetFlow packet 122 includes Data FlowSet 1200 as flow information. The first four bytes of a Data FlowSet 1200 store a FlowSet ID and the data length of the Data FlowSet.

Hereinafter, fields of the Data FlowSet 1200 to be transferred to the analyzer 102 and information to be stored in the fields are described.

A destination IP address 1201, a source IP address 1202, a destination port number 1203, a source port number 1204, and a protocol number 1215 store the values of the destination IP address 521, the source IP address 522, the protocol number 523, the destination port number 524, and the source port number 525 in the flow identification information 511.

A received packet count 1205 and a received byte count 1206 store the values of the received packet count 531 and the received byte count 532 in the statistical information 512.

A peak rate of received packet count 1207, a peak time of received packet count 1208, a peak rate of received byte count 1209, and a peak time of received byte count 1210 store the values of the peak rate of received packet count 53408, the peak time of received packet count 53409, the peak rate of received byte count 53410, and the peak time of received byte count 53411 in the short-term analysis information 534.

A variance of rate of received packet count 1211 and a variance of rate of received byte count 1212 store the values of the variance of rate of received packet count 53412 and the variance of rate of received byte count 53413 in the short-term analysis information 534.

A packet burst count 1213 and a byte burst count 1214 store the values of the packet burst count 53418 and the byte burst count 53419 in the short-term analysis information 534.

As to the fields from the peak rate of received packet count 1207 to the byte burst count 1214 are uniquely extended by newly assigning non-standard field type values. For this reason, the uniquely extended fields can be assigned a field type value not included in this embodiment within the non-standard range and their field lengths can be changed, for example to 8 bytes.

The data format of the Data FlowSet 1200 does not have to be limited to the one illustrated in FIG. 12. For example, when the bit 312 for the receive rate variance analysis is disabled, the fields of the variance of rate of received packet count 1211 and the variance of rate of received byte count 1212 can be excluded.

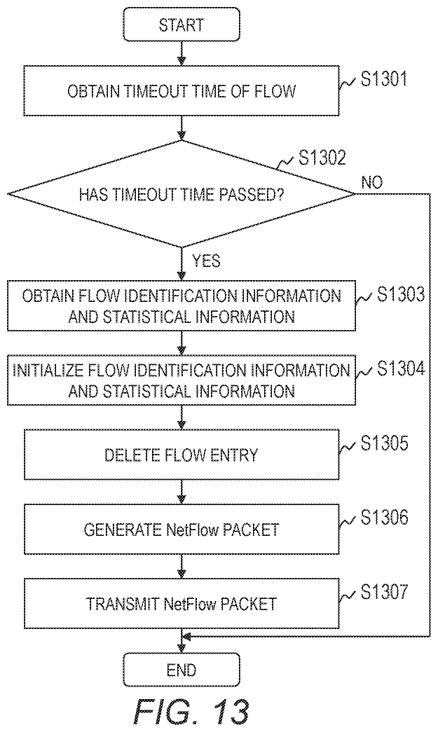

FIG. 13 is a flowchart illustrating an example of transmitting the NetFlow packet 122 to be performed by the flow information collection apparatus 101 in Embodiment 1.

The flow information collection apparatus 101 periodically executes this processing of transmitting a NetFlow packet 122. FIG. 13 illustrates the processing of transmitting a NetFlow packet 122 about one flow. In a case where the flow information DB 242 includes multiple flow entries 501, the same processing is performed on each flow entry 501.

The flow information monitoring module 237 obtains the value of the timeout time 533 (the time of timeout) in the flow entry 501 registered in the flow information DB 242 (Step S1301) and determines whether the timeout time has passed (Step S1302).

In case where the timeout time has not passed (No at Step S1302), the flow information monitoring module 237 terminates the processing of transmitting a NetFlow packet 122.

In a case where the timeout time has passed (Yes at Step S1302), the flow information monitoring module 237 obtains the values of the flow identification information 511 and the statistical information 512 of the flow entry 501 (Step S1303) and outputs them to the NetFlow packet generation module 238. The flow information monitoring module 237 initializes the flow identification information 511 and the statistical information 512 of the flow entry 501 (Step S1304) and deletes the flow entry 501 from the flow information DB 242 (Step S1305).

The NetFlow packet generation module 238 generates a NetFlow packet 122 including a Data FlowSet 1200 based on the flow identification information and the statistical information received from the flow information monitoring module 237 (Step S1306) and outputs the NetFlow packet 122 to the packet transmitting module 239. The format of the Data FlowSet 1200 is as illustrated in FIG. 12.

The packet transmitting module 239 transmits the NetFlow packet 122 received from the NetFlow packet generation module 238 to the analyzer 102 through the network interface 206-2 (Step S1307) and notifies the flow information monitoring module 237 of the completion of the transmitting. After receiving the notification, the flow information monitoring module 237 terminates the processing of transmitting a NetFlow packet 122.

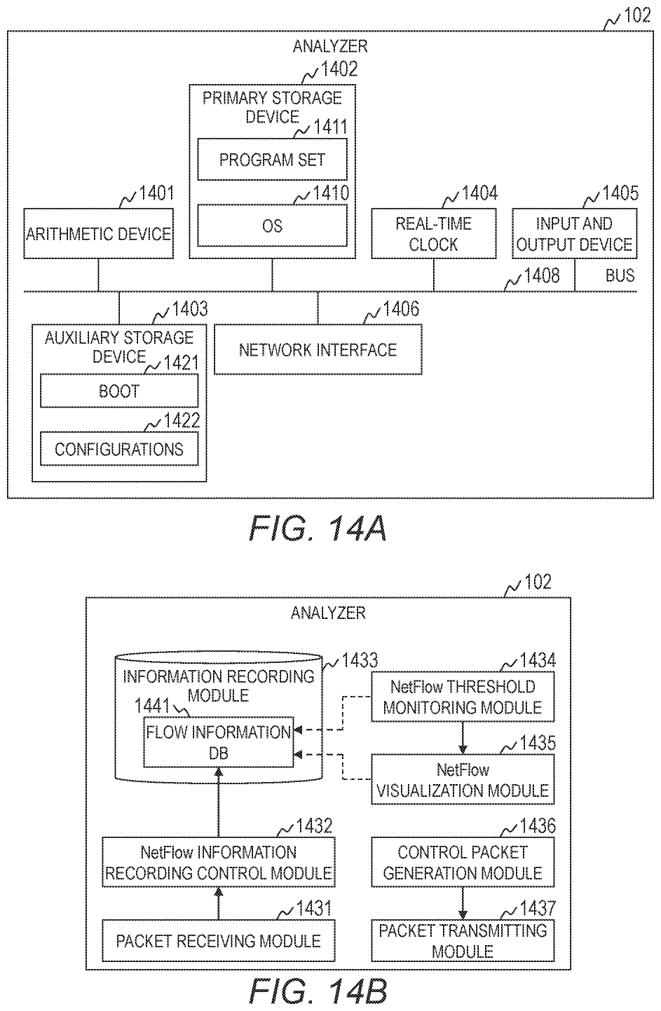

FIGS. 14A and 14B are block diagrams illustrating an example of a configuration of the analyzer 102 in Embodiment 1.

The hardware configuration is described first. The analyzer 102 includes an arithmetic device 1401, a primary storage device 1402, an auxiliary storage device 1403, a real-time clock 1404, an input and output device 1405, and a network interface 1406. These hardware components are interconnected by a bus 1408.

The arithmetic device 1401, the primary storage device 1402, the auxiliary storage device 1403, the real-time clock 1404, the input and output device 1405, and the network interface 1406 are the same as the arithmetic device 201, the primary storage device 202, the auxiliary storage device 203, the real-time clock 204, the input and output device 205, and the network interface 206, respectively.

Next, the software configuration is described. In FIG. 14B, the solid lines represent inputting and outputting information; the dotted lines represent referring to information.

The BOOT 1421 is a program to be executed when the analyzer 102 starts. The configurations 1422 include configuration information for controlling the programs included in the program set 1411. For example, the configurations 1422 include control information for a NetFlow threshold monitoring module 1434, a NetFlow visualization module 1435, and a control packet generation module 1436. The configurations 1422 may be stored in advance in the auxiliary storage device 1403 or specified from the external through the input and output device 1405.

The operating system (OS) 1410 is stored in the auxiliary storage device 1403 and the BOOT 1421 deploys the OS 1410 to the primary storage device 1402 and executes it.

The program set 1411 includes programs for implementing functions to analyze NetFlow packets 122 received from the flow information collection apparatus 101. The program set 1411 is stored in the auxiliary storage device 1403 and the OS 1410 deploys it to the primary storage device 1402 and executes the programs. Instead of the OS 1410, the BOOT 1421 may deploy the program set 1411 to the primary storage device 1402 and execute the programs.

The program set 1411 includes a packet receiving module 1431, a NetFlow information recording control module 1432, an information recording module 1433, a NetFlow threshold monitoring module 1434, a NetFlow visualization module 1435, a control packet generation module 1436, and a packet transmitting module 1437.

The information recording module 1433 manages a data store for storing a variety of information. Specifically, the information recording module 1433 manages a flow information DB 1441. The flow information DB 1411 may be stored in the primary storage device 1402 or the auxiliary storage device 1403.

The packet receiving module 1431 performs receiving NetFlow packets 122 arrived at the network interface 1406 and outputs them to the NetFlow information recording control module 1432.

The NetFlow information recording control module 1432 extracts flow information from each NetFlow packet 122 and records the extracted flow information to the flow information DB 242 together with the time of receipt.

The NetFlow threshold monitoring module 1434 monitors the traffic amount of each flow based on the flow information and detects increase in traffic based on the result of comparison with a predetermined threshold. The threshold can be given from the configurations 1422.

The NetFlow visualization module 1435 presents information about flows based on the flow information stored in the flow information DB 1441 with the input and output device 1405. For example, the NetFlow visualization module 1435 presents a graph showing temporal transition of the traffic amount of each flow. Although this embodiment is configured to output the information to the input and output device 1405, the information may be output by using communication such as HTTP to an external apparatus through the packet transmitting module 1437 and the network interface 1406.

The control packet generation module 1436 generates the control packet including configuration information for controlling the short-term analysis by the flow information collection apparatus 101 and outputs the control packet to the packet transmitting module 1437. The configuration information included in the control packet may be set from the configurations 1422 or provided from an external through the input and output device 1405.

The packet transmitting module 1437 receives the control packet generated by the control packet generation module 1436 and transmits the control packet to the flow information collection apparatus 101 through the network interface 1406.

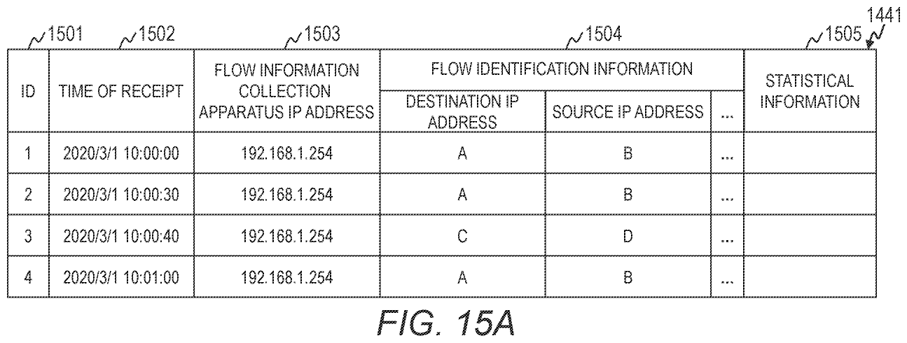

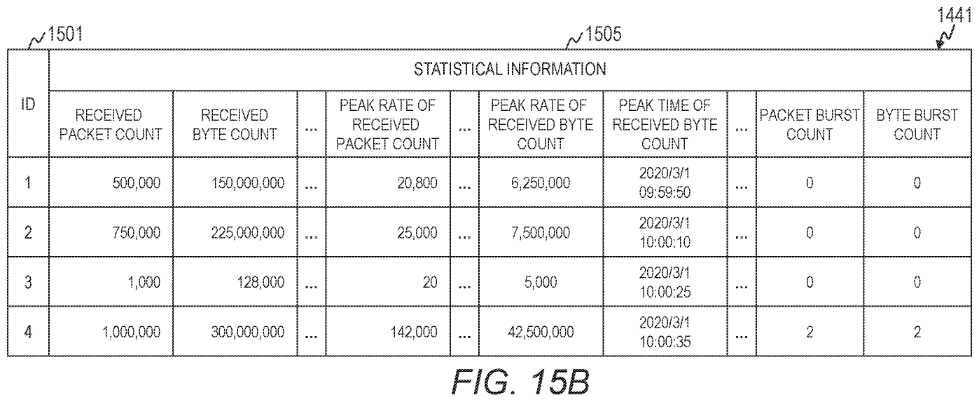

FIGS. 15A and 15B are diagrams illustrating an example of the data structure of the flow information DB 1441 in Embodiment 1.

The flow information DB 1441 is information in a table format and stores entries each including an ID 1501, a time of receipt 1502, a flow information collection apparatus IP address 1503, flow identification information 1504, and statistical information 1505. One entry corresponds to a Data FlowSet 1200 included in a NetFlow packet 122.

The ID 1501 is a field for storing the identification information of the entry. The time of receipt 1502 is a field for storing the time of receipt of the NetFlow packet 122. The flow information collection apparatus IP address 1503 is a field for storing the IP address of the flow information collection apparatus 101 that transmits the NetFlow packet 122.

The flow identification information 1504 are fields for storing flow identification information included in the Data FlowSet 1200. For example, it stores values such as the destination IP address 1201 and the source IP address 1202.

The statistical information 1505 are fields for storing statistical information included in the Data FlowSet 1200. For example, it stores the values such as the received packet count 1205, the received byte count 1206, the peak rate of received packet count 1207, the peak rate of received byte count 1209, the peak time of received byte count 1210, the packet burst count 1213, and the byte burst count 1214.

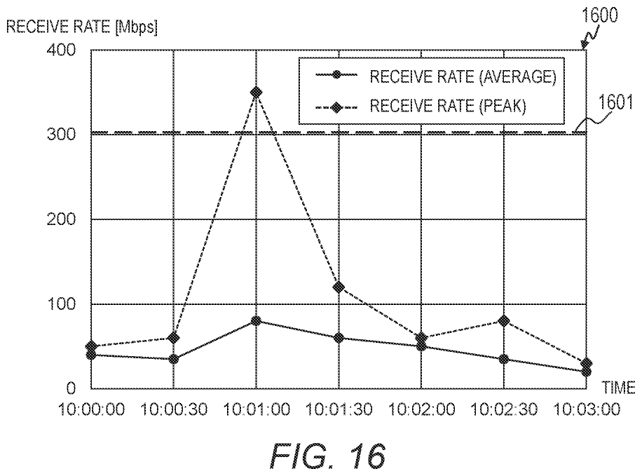

FIG. 16 is a diagram illustrating an example of information presented by the NetFlow visualization module 1435 in Embodiment 1.

The NetFlow visualization module 1435 presents an image 1600 as a result of detection of a burst. The image 1600 includes a graph showing transition of an average of the receive rate and a peak of the receive rate of a flow in a unit time; the horizontal axis represents time and the vertical axis represents receive rate. The unit time may be given from the configurations 1422, for example. The unit time in the example of FIG. 16 is 30 seconds. The unit time does not need to be the same as the flow monitoring period of the flow information collection apparatus 101; it may be longer than the flow monitoring period.

The NetFlow visualization module 1435 accesses the flow information DB 1441 to select the entries of the same flow recorded within a unit time, integrates the received byte count in the entries, divides the result by the unit time to calculate the average of the receive rate.

The NetFlow visualization module 1435 accesses the flow information DB 1441 to select the entries of the same flow recorded within a unit time, obtains the peak rate of the received byte count from the entries, and employs the highest peak rate of the received byte count as the peak of the receive rate. The NetFlow visualization module 1435 may further obtain the peak time of the rate of the received byte count at which the highest peak rate of the received byte count occurs to show it in the graph.

For the burst detection by the NetFlow threshold monitoring module 1434, a receive rate for determining that a burst occurs is specified in advance as a burst detection threshold. The NetFlow threshold monitoring module 1434 determines that a burst occurs when the peak rate of the received byte count exceeds the threshold. The burst detection threshold may be given from the configurations 1422, for example. In FIG. 16, the thick broken line 1601 represents the burst detection threshold.

In a case where a burst is detected, the NetFlow visualization module 1435 may display an alert indicating occurrence of a burst. Further, the NetFlow visualization module 1435 may transmit a packet indicating detection of a burst in a Syslog to a control apparatus that communicates with the analyzer 102, although the analyzer 102 in this embodiment is configured not to connect to any apparatus except for the flow information collection apparatus 101.

According to Embodiment 1, the flow information collection apparatus 101 performs analysis of flow information received within a minute time period while collecting the flow information. Hence, the flow information collection apparatus 101 can generate short-term analysis information indicating a local change of a flow and include the short-term analysis information into flow information. The analyzer 102 therefore can detect a local change of a flow like a microburst, which cannot be noticed of with the conventional flow information. The processing load to the analyzer 102 does not increase because of the generation of the information.

Note that the short-term analysis may be conducted on only either the received packet count or the received byte count.

### Embodiment 2

Embodiment 2 is different from Embodiment 1 in the configuration of the network flow monitoring system. The following describes Embodiment 2 mainly in differences from Embodiment 1.

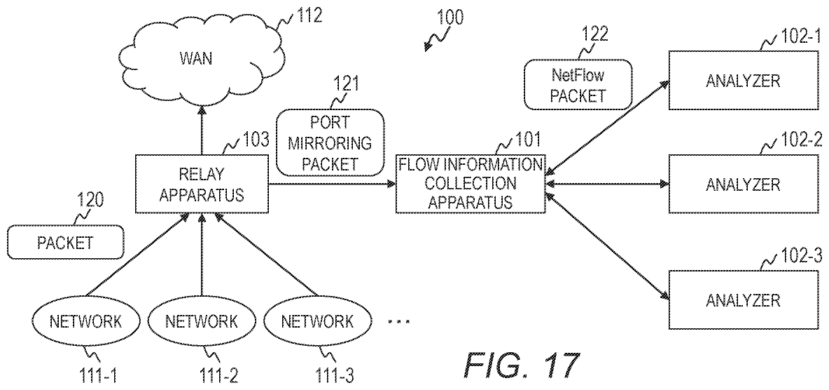

FIG. 17 is a diagram illustrating a network flow monitoring system 100 in Embodiment 2.

The network flow monitoring system 100 includes a relay apparatus 103, a flow information collection apparatus 101, and a plurality of analyzers 102-1, 102-2, and 102-3. When the analyzers 102-1, 102-2, and 102-3 do not need to be distinguished, the following description refers to each of them as analyzer 102. Although the network flow monitoring system 100 in FIG. 17 includes three analyzers 102-1, 102-2, and 102-3, the number of the analyzers 102 is not limited to three.

Embodiment 2 is different from Embodiment 1 in the point where the flow information collection apparatus 101 is connected to a plurality of analyzers 102. The flow information collection apparatus 101 transmits the identical NetFlow packets 122 to each of the analyzers 102.

The hardware configuration and the software configuration of the flow information collection apparatus 101 in Embodiment 2 are the same as those in Embodiment 1. The processing of the flow information collection apparatus 101 in Embodiment 2 is the same as that in Embodiment 1.

The hardware configuration and the software configuration of an analyzer 102 in Embodiment 2 are the same as those in Embodiment 1. The processing of the analyzer 102 in Embodiment 2 is the same as that in Embodiment 1. Each of the analyzer 102 may have different usage of the flow information. The items to be monitored may be distributed among the analyzers 102: for example, monitoring transition of the overall number of flows based on the flow information is assigned to the analyzer 102-1, monitoring transition of the overall traffic amount based on the received byte count is assigned to the analyzer 102-2, and monitoring n local change in traffic amount based on the peak rate of the received byte count and the number of byte bursts is assigned to the analyzer 102-3.

To control the flow information collection apparatus 101, the system administrator may transmit control packets by operating one of the analyzers 102 or set the IP address of an analyzer 102 allowed to transmit control packets to the configuration 222 so that filtering by the packet identification module 232 will work.

According to Embodiment 2, the flow information collection apparatus 101 connects to a plurality of analyzers 102 to achieve redundancy of the analyzer 102.

### Embodiment 3

Embodiment 3 is different from Embodiment 1 in the configuration of the network flow monitoring system. The following describes Embodiment 3 mainly in differences from Embodiment 1.

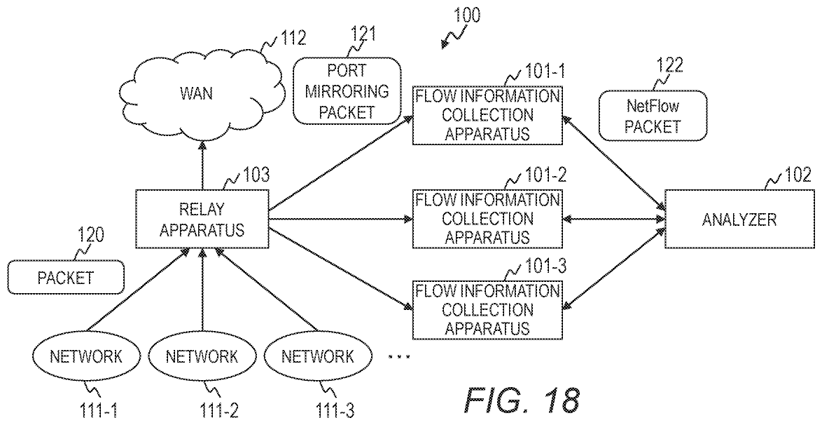

FIG. 18 is a diagram illustrating a network flow monitoring system 100 in Embodiment 3.

The network flow monitoring system 100 includes a relay apparatus 103, a plurality of flow information collection apparatuses 101-1, 101-2, and 101-3, and an analyzer 102. When the flow information collection apparatuses 101-1, 101-2, and 101-3 do not need to be distinguished, the following description refers to each of them as flow information collection apparatus 101. Although the network flow monitoring system 100 in FIG. 18 includes three flow information collection apparatuses 101-1, 101-2, and 101-3, the number of flow information collection apparatuses 101 is not limited to three.

Embodiment 3 is different from Embodiment 1 in the point where a plurality of flow information collection apparatuses 101 are connected to the analyzer 102. Each flow information collection apparatuses 101 transmits NetFlow packets 122.

The hardware configuration and the software configuration of each flow information collection apparatus 101 in Embodiment 3 are the same as those in Embodiment 1. The processing of the flow information collection apparatus 101 in Embodiment 3 is the same as that in Embodiment 1.

The hardware configuration and the software configuration of the analyzer 102 in Embodiment 3 are the same as those in Embodiment 1. The processing of the analyzer 102 in Embodiment 3 is the same as that in Embodiment 1. The NetFlow threshold monitoring module 1434 and the NetFlow visualization module 1435 may aggregate the flow information on the same flow received from a plurality of flow information collection apparatuses 101 to perform their processing. For example, they can sum up the values of the peak rate of the received byte count included in the flow information obtained from different flow information collection apparatuses 101 only in a case where the flow information includes the same peak time of rate of the received byte count. As understood from this example, regarding the peak rate of the received packet count, the peak rate of the received byte count, the number of the packet bursts, and the number of the byte bursts, the analyzer 102 may aggregate the values on one flow, depending on the monitoring target and the monitoring conditions.

Each flow information collection apparatus 101 may have different short-term analysis configuration information 241. For example, the flow information collection apparatuses 101 can have short-term analysis configuration information 241 including different values for the receive rate measurement period 302 to perform the short-term analysis of different granularities on the same flow. In this case, the analyzer 102 does not aggregate flow information on the same flow included in NetFlow packets 122 received from the flow information collection apparatuses 101.

According to Embodiment 3, a plurality of flow information collection apparatuses 101 are connected to the analyzer 102 to achieve redundancy of the flow information collection apparatus 101. Further, effect of distributing the load to receive port mirroring packets 121 transmitted from the relay apparatus 103 can be expected.

As set forth above, this invention has been described specifically with reference to the accompanying drawings. However, this invention is not limited to those specific configurations but includes various modifications and equivalent configurations within the scope of the appended claims.

What is claimed is:

1. A flow information collection apparatus comprising:
an arithmetic device;
a storage device coupled to the arithmetic device; and
a network interface coupled to the arithmetic device,
the flow information collection apparatus being configured to couple to an analyzer to be able to communicate with the analyzer, and
the arithmetic device being configured to:
generate flow information by aggregating a plurality of packets having common communication attributes in units of a first time period;
generate short-term analysis information indicating short-term characteristics of a flow by repeatedly analyzing the plurality of packets used to generate the flow information with respect to short-term characteristics of the flow in a second time period shorter than the first time period, and add the generated short-term analysis information to the flow information;
generate a packet including the flow information adding the short-term analysis information; and
transmit the packet to the analyzer.

2. The flow information collection apparatus according to claim 1,
wherein the flow information includes a receive rate of a number of packets and a receive rate of data amount, and
wherein the arithmetic device is configured to calculate, in the analyzing, a peak value of at least either the receive rate of the number of packets or the receive rate of the data amount.

3. The flow information collection apparatus according to claim 1,
wherein the flow information includes a receive rate of a number of packets and a receive rate of data amount, and
wherein the arithmetic device is configured to calculate, in the analyzing, a variance of at least either the receive rate of the number of packets or the receive rate of the data amount.

4. The flow information collection apparatus according to claim 1,
wherein the flow information includes a receive rate of a number of packets and a receive rate of data amount, and
wherein the arithmetic device is configured to detect, in the analyzing, occurrence of at least either a burst caused by increase of received packets or a burst caused by increase of received data amount, and count occurrence of a burst.

5. The flow information collection apparatus according to claim 1,
wherein the flow information includes a receive rate of a number of packets and a receive rate of data amount, and
wherein the arithmetic device is configured to:
calculate a packet loss rate;
modify the receive rate of the number of packets and the receive rate of the data amount based on the packet loss rate; and
perform the analyzing using at least either the modified receive rate of the number of packets or the modified receive rate of the data amount.

6. The flow information collection apparatus according to claim 1,
wherein the storage device stores configuration information defining specifics of the analyzing and including the second time period, and
wherein the arithmetic device is configured to perform the analyzing based on the configuration information.

7. A method for generating flow information to be executed by a flow information collection apparatus,
the flow information collection apparatus including an arithmetic device, a storage device coupled to the arithmetic device, and a network interface coupled to the arithmetic device and being configured to couple to an analyzer to be able to communicate with the analyzer, and
the method for generating flow information including:
a first step of generating, by the arithmetic device, flow information by aggregating a plurality of packets having common communication attributes in units of a first time period;
a second step of generating, by the arithmetic device, short-term analysis information indicating short-term characteristics of a flow by repeatedly analyzing the plurality of packets used to generate the flow information with respect to short-term characteristics of the flow in a second time period shorter than the first time period, and adding the generated short-term analysis information to the flow information;
a third step of generating, by the arithmetic device, a packet including the flow information adding the short-term analysis information; and
a fourth step of transmitting, by the arithmetic device, the packet to the analyzer.

8. The method of generating flow information according to claim 7,
wherein the flow information includes a receive rate of a number of packets and a receive rate of data amount, and
wherein the second step includes a step of calculating, by the arithmetic device, a peak value of at least either the receive rate of the number of packets or the receive rate of data amount in the analyzing.

9. The method of generating flow information according to claim 7,
wherein the flow information includes a receive rate of a number of packets and a receive rate of data amount, and
wherein the second step includes a step of calculating, by the arithmetic device, a variance of at least either the receive rate of the number of packets or the receive rate of the data amount in the analyzing.

10. The method of generating flow information according to claim 7,
wherein the flow information includes a receive rate of a number of packets and a receive rate of data amount, and
wherein the second step includes steps of detecting, by the arithmetic device, occurrence of at least either a burst caused by increase of received packets or a burst caused by increase of received data amount, and counting occurrence of burst in the analyzing.

11. The method of generating flow information according to claim 7,
wherein the flow information includes a receive rate of a number of packets and a receive rate of data amount, and
wherein the second step includes:
a step of calculating, by the arithmetic device, a packet loss rate;
a step of modifying, by the arithmetic device, the receive rate of the number of packets and the receive rate of the data amount based on the packet loss rate; and
a step of performing, by the arithmetic device, the analyzing using at least either the modified receive rate of the number of packets or the modified receive rate of the data amount.

12. The method of generating flow information according to claim 7,
wherein the storage device stores configuration information defining specifics of the analyzing and including the second time period, and
wherein the second step includes a step of performing, by the arithmetic device, the analyzing the packets based on the configuration information.
